(19) United States
(12) Patent Application Publication
(10) Pub. No.: US 2004/0101782 A1
(43) Pub. Date: May 27, 2004

(54) Method for making optical device structures

(75) Inventor: Thomas Bert Gorczyca, Schenectady, NY (US)

Correspondence Address: General Electric Company, CRD Patent Docket Rm 4A59, P.O. Box 8, Bldg. K-1, Schenectady, NY, 12301, US

(73) Assignee: General Electric Company

(21) Appl. No.: 10/306,439

(22) Filed: Nov. 27, 2002

(51) Int. Cl. G02B 6/10

(52) U.S. Cl. 430/290; 430/321; 430/330

(57) ABSTRACT

A method of forming an optical device structure having a first region and a second region. The method comprises: providing a polymerizable composite comprising a polymer binder and an uncured monomer, depositing the polymerizable composite on a substrate to form a layer, patterning the layer to define an exposed area and an unexposed area of the layer, irradiating the exposed area of layer, and volatilizing the uncured monomer to form the optical device structure. The step of volatilizing the uncured monomer forms a surface topography and a compositional change between the first region and the second region. The compositional change creates a gradient in refractive index between the first region and the second region.

### BACKGROUND OF INVENTION

The invention relates to a method of forming an optical device structure comprising an organic polymer composite. More particularly, the present invention relates to a method of forming a topographic profile in an optical device structure. The invention can be used for forming an optical device structure comprising a clad and a core layer.

Modern high-speed communications systems are increasingly using optical fibers for transmitting and receiving high-bandwidth data. The excellent properties of polymer optical fibers with respect to flexibility, ease of handling and installation are an important driving force for their implementation in high bandwidth, short-haul data transmission applications such as fiber to the home, local area networks, and automotive information, diagnostic, and entertainment systems.

In any type of optical communication system there is the need for interconnecting different discrete components. These components may include devices, such as lasers, detectors, fibers modulators, and switches. Polymer-based devices, such as waveguides, offer a viable way of interconnecting these components, and offer a potentially inexpensive interconnection scheme. Such devices should be able to couple light vertically into or out of the waveguide with good efficiency and low propagation losses, which in turn are determined primarily by the quality of both the polymer and the device boundary.

A proper selection of polymeric materials is necessary for making polymeric optical waveguides that display a low attenuation and improved thermal stability without an excessive increase in scattering loss. Moreover, a well-defined introduction of light-focusing or light-scattering elements is potentially useful to obtain controlled emission of light in polymeric optical waveguides.

A requirement for making opto-electronic multi-chip modules is to provide an optical interconnect between the electronic circuitry and the “optical bench” portion of the package. One method to do this is to have a vertical cavity surface emitting laser (hereinafter also referred to as “VCSEL”), which is integrated with and controlled by the electronic portion of the module, direct its laser light vertically into the base of the optical portion of the module. An approximate 45-degree angle “mirror” is required to change the direction of the laser light from a vertical to a horizontal direction, thus directing it into the optical bench. This mirror is difficult to fabricate with conventional methods for several reasons. The mirror should have a surface inclined 45 degrees with respect to the horizontal surface of the VCSEL. When the mirror is positioned over a VCSEL, it reflects a vertical light beam projected from the VCSEL to a horizontal direction into a polymer waveguide comprising the optical bench. Furthermore, the mirror surface must be very smooth to limit losses in light transmission, and it must be precisely aligned to the underlying VCSEL. Another problem encountered with planar polymer waveguides is the necessity to have smooth edges on the waveguide structures to limit light transmission losses. It is believed that the use of conventional reactive ion etching techniques to define waveguide structures will generate edges which will be too rough to use with single mode light transmission. Previously, 45-degree angle mirrors were defined either by laser ablation of the core polymer material at an appropriate angle, reactive ion etching using a gray scale mask, or by embossing the required structure onto the polymer surface. Waveguide structures can be formed by several techniques including coating a lower cladding layer on a suitable substrate and forming a trench in the clad layer by embossing, etching or development, and filling the trench with a core material, and over-coating with a top clad layer. Ridge waveguides can be formed by coating a lower clad and core layer onto a substrate, patterning the core by etching or development to form a ridge, and over-coating with an upper clad layer. Planar waveguides can be formed by coating a lower clad and core material over a substrate, defining the waveguide by UV exposure and depositing an upper clad layer over it. Reactant diffusion occurs between the unexposed core and surrounding clad layers into the exposed core area changing its refractive index (hereinafter also referred to as “RI”) to form the waveguide.

There continues to be a need for low loss radiation curable materials that can be used to make optical devices with control of at least one of topography, refractive index, or composition by a more direct process having fewer manufacturing steps. Furthermore, it would be desirable to develop a process that will enable the formation of optical device structures, such as waveguide structures with smooth, tapered edges to allow vertical interconnection with other optical devices or laser devices, without use of reactive ion etching or development, by using a single polymerizable composite as the raw material.

### SUMMARY OF INVENTION

Accordingly, one aspect of the invention is to provide a method of forming an optical device structure having a first region and a second region. The method comprises the steps of: providing a polymerizable composite comprising a polymer binder and an uncured monomer; depositing the polymerizable composite on a substrate to form a layer; patterning the layer to define an exposed area and an unexposed area of the layer; irradiating the exposed area of layer; and volatilizing the uncured monomer to form the optical device structure.

A second aspect of the invention is to provide a method of forming a topographic profile in an optical device structure having a first region and a second region. The method comprises the steps of: providing a polymerizable composite; where the polymerizable composite comprises at least one polymer binder and at least one uncured monomer; depositing the polymerizable composite on a surface of a substrate to form a layer; patterning the layer to define an exposed area and an unexposed area of the layer; curing a portion of the layer to form a polymerized portion and an uncured portion; removing the uncured monomer from at least one of the polymerized portion and the uncured portion, where the removal of the uncured monomer forms the topographic profile. The topographic profile comprises a change in at least one of composition, refractive index (also referred to hereinafter as “RI”), coefficient of thermal expansion, glass transition temperature, birefringence, light transmission, modulus, dielectric properties, and thermal conductivity of the optical device structure. The polymer binder comprises at least one of a cyclic olefin copolymer, an acrylate polymer, a polyester, a polyimide, a polycarbonate, a polysulfone, a polyphenylene oxide, a polyether ketone, a polyvinyl fluoride, and combinations thereof. The uncured monomer comprises at least one of an acrylic monomer, a cyanate monomer, a vinyl monomer, an epoxide-containing monomer, and combinations thereof.

A third aspect of the invention is to provide a method of making an optical device structure having a first region and a second region. The method comprises the steps of: providing a polymerizable composite comprising at least one polymer binder and at least one uncured monomer; depositing a layer of the polymerizable composite on at least one substrate comprising a clad layer; patterning the layer using a mask to define an exposed area and an unexposed area of the layer; irradiating the exposed area of the layer; and volatilizing the uncured monomer to form the optical device structure. The step of volatizing forms a topography and a compositional change in the said optical device structure.

### BRIEF DESCRIPTION OF DRAWINGS

FIG. 1 is a schematic representation showing the curing of a polymerizable composite comprising a polymeric binder and a UV-polymerizable monomer;

FIG. 2 is a schematic representation showing the creation of a surface topography after a post radiation-cure evaporation of monomer;

FIG. 3 is a schematic diagram illustrating creation of a surface topography array by UV irradiation of a polymerizable composite material through a gray scale mask;

FIG. 4 is a plot showing refractive index contrast between a UV-exposed and UV-unexposed polymer/epoxy thin film deposited on a silicon wafer;

FIG. 5 is a schematic plot showing the dependence of composite refractive index of a material comprising an optical device on the quantity and refractive index of cured components;

FIG. 6 is a schematic diagram showing the creation of a photo-patterned layer topography from a polymerizable composite;

FIG. 7 is a schematic diagram showing the creation of a photo-patterned stacked layer topography from a polymerizable composite;

FIG. 8 is a schematic diagram illustrating creation of a VCSEL-integrated micro-lens array;

FIG. 9 is a scanning electron micrograph showing a plurality of dome-shaped structures formed from a post-irradiation post-bake step of a 60:40 mixture by weight of poly(methyl methacrylate) and 3-4-epoxycyclohexylmethyl-3,4-epoxycyclohexane carboxylate (also referred to hereinafter as “CY 179”);

FIG. 10 is a scanning electron micrograph showing a plurality of dome-shaped structures formed from a post-irradiation post-bake step of a 60:40 mixture by weight of poly(methyl methacrylate) and CY 179;

FIG. 11 is a scanning electron micrograph showing dimple-shaped structures formed from a post-irradiation post-bake step of a 60:40 mixture by weight of poly(methyl methacrylate) and CY 179;

FIG. 12 is a schematic diagram illustrating creation of a VCSEL-integrated micro beam-shaping lens array;

FIG. 13 is a plot showing the input intensity profile of a laser source of a VCSEL;

FIG. 14 is a plot showing the output intensity profile of a laser source of a VCSEL; and

FIG. 15 is a scanning electron micrograph showing “domes” formed after exposure to UV radiation and curing of a 60:40 mixture by weight of poly(methyl methacrylate) and CY 179.

### DETAILED DESCRIPTION

In the following description, like reference characters designate like or corresponding parts throughout the figures. It is also understood that terms such as “top”, “bottom”, “outward”, inward”, and the like are words of convenience and are not to be construed as limiting terms.

It should be understood that the figures and drawings in general are for the purpose of describing a preferred embodiment of the invention and are not intended to limit the invention thereto.

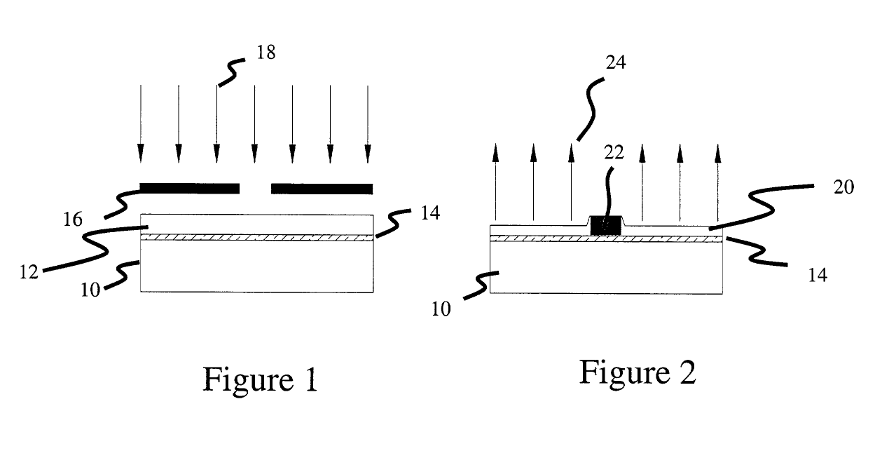

FIG. 1 is a schematic representation showing the curing of a polymerizable composite comprising a polymeric binder and a radiation-polymerizable monomer. A layer of polymerizable composite 12 is deposited on a surface 14 of a substrate 10. The polymerizable composite comprises a polymer binder and an uncured monomer. The patterning of polymerizable composite 12 is carried out using a mask 16 so as to define an area that can be exposed to curing radiation 18. Ultraviolet (UV) radiation is preferably used as the curing radiation. During the curing step, the monomer polymerizes in the areas exposed to the curing radiation. In addition to UV radiation, other forms of irradiation, such as, but not limited to, a direct-write laser can also be used. Although the curing radiation is referred to herein as UV radiation, it is understood that other radiation sources may be used to cure the polymerizable composite as well.

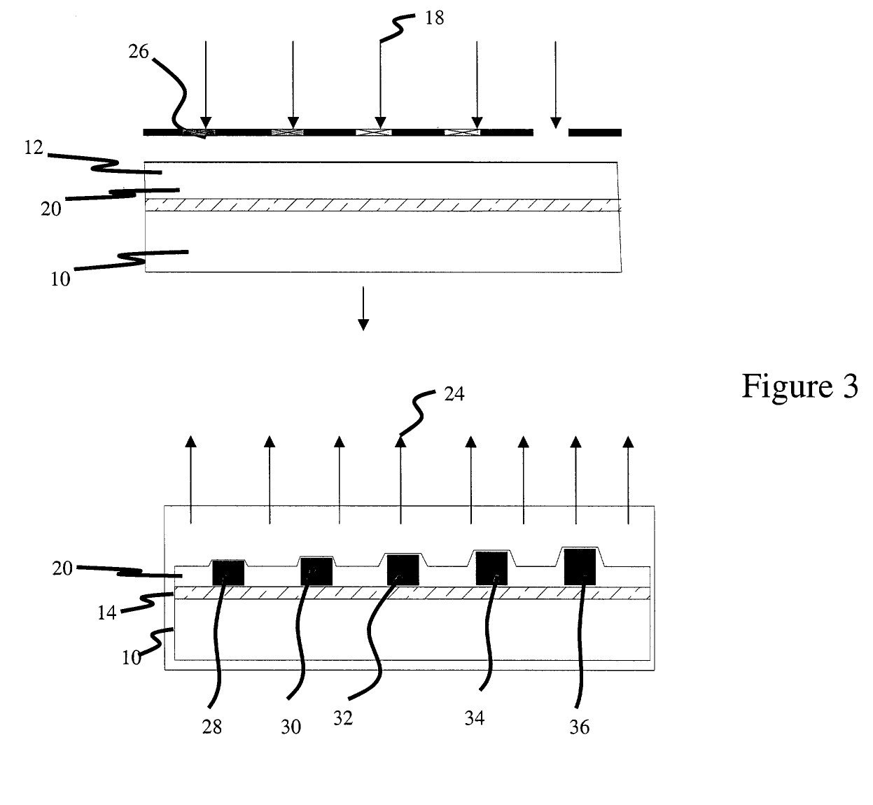

FIG. 2 is a schematic diagram showing the baking 24 (hereinafter also referred to as “volatilizing”) of uncured monomer from an area of the polymerizable composite 12 that is not exposed to UV irradiation. In addition, any uncured monomer remaining in the exposed portions, or areas, is volatized as well. This process results in evaporation of the volatile uncured monomer component from the unexposed areas, thereby resulting in creation of an optical device structure 22 having a surface 20. The surface 20 of the optical device structure has a first region and a second region such that each region can have a unique surface topography and a unique composition. The first region and the second region generally refer to different areas on the optical device structure. For example, the first region could be the surface on which an optical device structure is formed, and the second region could be the surface of the optical device structure itself. Optical device structures that may be formed by the methods disclosed herein are described in U.S. patent application Ser. No. ______, entitled “Optical Device Structures Based on Photo-definable Polymerizable Composites,” by Thomas B. Gorczyca and Min Yei Shih, filed ______, the contents of which are incorporated herein by reference in their entirety.

By suitably varying the process conditions and the composition of the polymerizable composite 12, it is possible to obtain a variety of surface topographies, therefore leading to a variety of optical device structures. In one embodiment, the surface topography includes at least one step. The step may be either an upward or a downward step. Moreover, the step can have an angled, concave, or convex profile. In one embodiment, the step forms an angle from about 5 degrees to about 90 degrees with respect to the surface of the substrate 14.

In addition to surface topography, the optical device structures resulting from the volatilizing 24 can also result in a compositional change. Among other factors, the compositional change is the combined result obtained from the polymerization of the monomer in the radiation-exposed areas, concomitant migration of adventitious monomer from the unexposed areas to the radiation exposed areas, and the volatilizing of uncured monomer, primarily from the areas unexposed to the radiation. In one embodiment, the radiation-induced polymerization of the monomer can be carried out such that only a portion of the polymerizable monomer is polymerized. The remaining monomer is volatilized in the succeeding bake step. This process of incomplete polymerization can lead to optical devices having topographies, compositional changes, and properties that are different from those where all of the monomer in the exposed area is polymerized. In many embodiments, the composition change creates a change in at least one of coefficient of thermal expansion, glass transition temperature, refractive index (also referred to hereinafter as “RI”), birefringence, light transmission, modulus, dielectric properties, and thermal conductivity of the optical device structure.

A consequence of the compositional change is the concomitant creation of a gradient in the refractive index between a first region and a second region of the optical device structure. The first region and the second region of the optical device structure can be represented, for example, by a core layer and a clad layer, respectively. The index of refraction of a medium is defined as the speed of light in a vacuum divided by the speed of light in the medium. The difference in refractive index between materials provides measurement of the amount a propagating light wave will refract or bend upon passing from one material to another material in which the velocity of the propagating light wave is different. In one embodiment, the refractive index gradient between core (i.e., a first region) and clad (i.e., a second region) is at least 0.2%. In many of the optical device structures described herein, the RI gradient between clad and core is about 5%. For fully polymeric systems, in which both the clad and core comprise fully polymerized material, a difference in RI between core and clad of up to about 20% difference may be achieved. For example, an optical device structure comprising a core having an RI of about 1.59 and a clad having an RI of about 1.55 would have a smooth RI gradient of about 2.6% across a transition width from about 0.5 microns to about 3 microns. Thin film gradient refractive index structures can be fabricated by controlling UV dose, amount of evaporation and initial starting materials. A gradient RI waveguide is preferable over a step RI waveguide because it provides a lower loss light transmission.

The polymerizable composite 12 comprises a polymer binder and an uncured monomer. The polymer binder comprises any polymer that is thermally stable during the monomer evaporation step. The polymer binder should also be compatible with the monomer chosen. In an embodiment, the polymer binder comprises at least one of an acrylate polymer, a polyetherimide, a polyimide, a siloxane-containing polyetherimide, a polyester, a polycarbonate, a siloxane-containing polycarbonate, a polysulfone, a siloxane-containing polysulfone, a polyphenylene oxide, a polyether ketone, a polyvinyl fluoride, and combinations thereof. In a particular embodiment, the acrylate polymer comprises at least one of poly(methyl methacrylate), poly(tetrafluoropropyl methacrylate), poly(2,2,2-triflouroethyl methacrylate), copolymers comprising structural units derived from acrylate polymers, and combinations thereof. In another embodiment, the polyimide comprises the building blocks, 2,2′-bis[4-(3,4-dicarboxyphenoxy)phenyl] propane dianhydride, 1,3-phenylenediamine, benzophenonetetracarboxylic acid dianhydride and 5(6)-amino-1-(4′-aminophenyl)-1,3-trimethylindane.

The uncured monomer comprises any monomer that is compatible with the polymer binder, can be polymerized by exposure to radiation, and will evaporate in the monomer form during the bake step. The monomer can be mono-functional; that is, it forms a thermoplastic polymer during irradiation. Alternatively, the monomer can be poly-functional; that is, it forms a thermosetting polymer matrix when irradiated. The monomers may react with both themselves and the polymer binder during irradiation. The uncured monomer comprises at least one of an acrylic monomer, a cyanate monomer, a vinyl monomer, an epoxide-containing monomer, and combinations thereof. Non-limiting examples of monomers include acrylic monomers, such as methyl methacrylate, 2,2,2-trifluoroethyl methacrylate, tetrafluoropropyl methacrylate, benzyl methacrylate, and glycol-based and bisphenol-based diacrylates and dimethacrylates; epoxy resins, such as, but not limited to: aliphatic epoxies; cycloaliphatic epoxies, such as CY-179; bisphenol-based epoxies, such as bisphenol A diglycidyl ether and bisphenol F diglycidyl ether; hydrogenated bisphenol-based and novolak-based epoxies; cyanate esters; styrene; allyl diglycol carbonate; and others.

In addition to the at least one polymer binder and one monomer, the polymerizable composite material may further include at least one of a photo-catalyst or a photo-initiator, a co-catalyst, an anti-oxidant, additives such as, but not limited to, chain transfer agents, photo-stabilizers, volume expanders, free radical scavengers, contrast enhancers, nitrones, and UV absorbers, and a solvent, the latter being present to facilitate spin coating the polymerizable composite material onto a substrate. The monomer may comprise from about 1% by weight to about 99% by weight of the polymerizable composite. In one embodiment, the monomer preferably comprises from about 5% to about 70% of the polymerizable composite. In a non-limiting example, the polymerizable composite comprises: polysulfone polymer binder (60 grams); 3-4-epoxycyclohexylmethyl-3,4-epoxycyclohexane carboxylate (also referred to hereinafter as “CY179”) (20 grams); triarylsulfonium hexafluoroantimonate catalyst (also referred to hereinafter as “Cyracure UVI-6976”) (0.5 gram); pentaerythritol tetrakis(3-(3,5-di-tert-butyl-4-hydroxyphenyl)propionate) antioxidant (also referred to hereinafter as “Irganox 1010”) (0.3 gram); and anisole solvent (210 grams).

The polymerizable composite may further comprise at least one photoinitiator. Non-limiting examples of photo-initiators that can be used for polymerizing a radiation-polymerizable monomer, such as an epoxy, include triarylsulfonium hexafluoroantimonate salt and triarylsulfonium hexafluorophosphate salt (also referred to hereinafter as “Cyracure”) photo-initiators, or, for an acrylate monomer, 1-hydroxy-cyclohexyl-phenyl-ketone, 2,2-dimethoxy-1,2-diphenylethan-1-one or 2-methyl-1[4-(methylthio)phenyl]-2-morpholinopropan-1-one (also referred to hereinafter as “Irgacure”) photo-initiators.

The photo-initiator present in each polymerizable composite is present in an amount sufficient to polymerize the uncured monomer upon exposure to radiation. The photo-initiator is generally present in an amount from about 0.01 parts to about 10 parts per 100 parts by weight of the overall polymerizable composite. In another embodiment, the photo-initiator is generally present in an amount from about 0.1 parts to about 5 parts per 100 parts by weight of the overall polymerizable composite.

Other additives may also be added to the polymerizable composite depending on the purpose and the end use of the resulting final materials. Examples of these include antioxidants, chain transfer agents, photo-stabilizers, volume expanders, free radical scavengers, contrast enhancers, nitrones and UV absorbers. Antioxidants include such compounds as phenols and particularly hindered phenols including tetrakis[methylene (3,5-di-tert-butyl-4-hydroxyhydrocinnamate)] methane (commercially available under the name Irganox 1010 from CIBA-GEIGY Corporation); sulfides; organoboron compounds; organophosphorous compounds; and N,N′-hexamethylenebis(3,5-di-tert-butyl-4-hydroxyhydrocinnamamide) (available from Ciba-Geigy under the trade name Irganox 1098). Chain transfer agents such as N-dodecanethiol can terminate a growing oligomer chain and start a new one with monomer, build a disulfide bond with another thiol radical, or terminate another oligomer chain. Photo stabilizers and, more particularly, hindered amine light stabilizers that can be used include, but are not limited to, poly[(6-morpholino-striazine-2,4-diyl)[2,2,6,6,-tetramethyl-4-piperidyl)imino]-hexamethylene[2,2,6,6,-tetramethyl-4-piperidyl)imino)] available from Cytec Industries under the trade name Cyasorb UV3346. Volume expanding compounds include such materials as the spiral monomers known in the art as Bailey's monomer. Suitable free radical scavengers include oxygen, hindered amine light stabilizers, hindered phenols, 2,2,6,6-tetramethyl-1-piperidinyloxy free radical (TEMPO), and the like. Suitable contrast enhancers include other free radical scavengers such as nitrones. UV absorbers include benzotriazole, hydroxybenzophenone, and the like. These additives may be included in quantities, based upon the total weight of the polymerizable composite, from about 0% to about 6%, and preferably from about 0.1% to about 2% by weight. Preferably all components of the polymerizable composite are in admixture with one another, and most preferably in a substantially uniform admixture.

When the radiation curable compounds described above are cured by ultraviolet radiation, it is possible to shorten the curing time by adding a photosensitizer, such as, but not limited to, benzoin, benzoin methyl ether, benzoin ethyl ether, benzoin isopropyl ether, benzil (dibenzoyl), diphenyl disulfide, tetramethyl thiuram monosulfide, diacetyl, azobisisobutyronitrile, 2-methyl-anthraquinone, 2-ethyl-anthraquinone or 2-tert-butylanthraquinone, to the monomer, oligomer, or polymer component or its solution. The proportion of the photo-sensitizer is preferably up to 5% by weight based on the weight of the curable compound.

The mask used for defining the area to be exposed to the radiation source can have various shapes, sizes, and different degrees of grayscale. Different grayscales will produce regions of different compositions. The use of a grayscale mask may thus be used to produce different topographies or array of topographies in a single exposure of a single layer of a polymerizable composite. FIG. 3 is a schematic diagram illustrating creation of optical devices 28-36 having an array of surface topographies by UV irradiation 18 of a polymerizable composite 12 through a gray scale mask 26. After volatilizing the uncured monomer, the process affords an array of optical devices having an array of topographies and refractive index gradients.

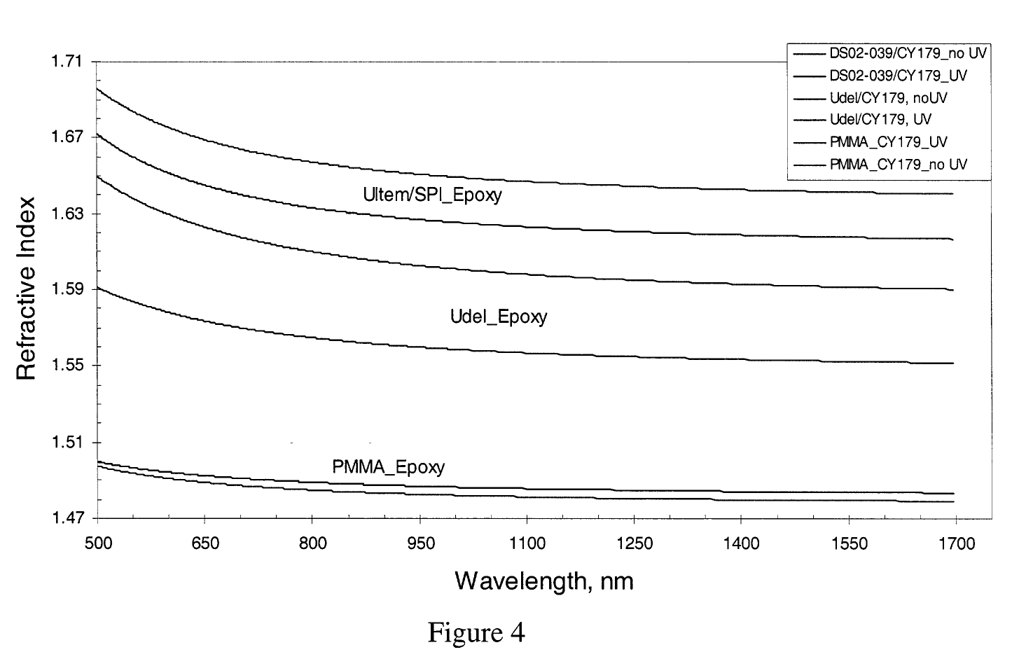

The UV irradiation curing of the monomer in the polymerizable composite results in a cured material having a refractive index that is different than of the polymerizable composite that is shielded from the UV radiation by the mask. FIG. 4 is a plot showing refractive index contrast between a UV-exposed and unexposed polymer/epoxy thin film deposited on a silicon wafer. As can be seen in FIG. 4, a wide range of refractive index differences can be achieved by properly choosing the polymer binder and the uncured monomer component.

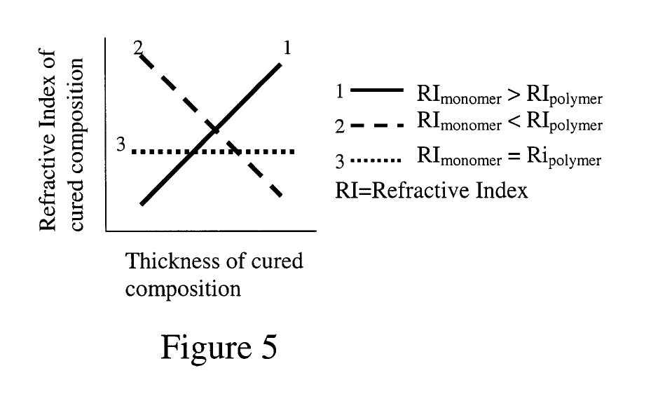

FIG. 5 is a schematic plot showing the dependence of composite refractive index of materials that may be used to form an optical device on the quantity and refractive index of cured components. Composite refractive index (hereinafter designated as “RI_{composite}”) depends on the quantity of the individual polymer components making up the composite polymer and their respective refractive indices, as shown in Equation (1):

RI_{composite}=Σ(Wₙ×RIₙ) (Eq. 1)

where “Wₙ” represents the weight percent of the n^{th} polymer component in the composite polymer, and “RIₙ” represents the refractive index of the n^{th} polymer component in the composite polymer. FIG. 5 shows that when the refractive index of the monomer (hereinafter designated as “RIₘₒₙₒₘₑᵣ”) is greater than the refractive index of the polymer binder (hereinafter designated as “RI_{polymer}”), following irradiation of the polymerizable composite using different tones of gray scale mask, the refractive index of the polymer composite increases with increasing thickness of the polymer composite. On the other hand, when RIₘₒₙₒₘₑᵣ is lower than RI_{polymer}, the refractive index of the polymer composite decreases with increasing thickness of the polymer composite. When RIₘₒₙₒₘₑᵣ is approximately equal to RI_{polymer}, the refractive index of the polymer composite remains relatively unchanged with thickness. Thus, the preparation and composition of the polymerizable composite can be tailored to meet the refractive index requirements of a particular optical device.

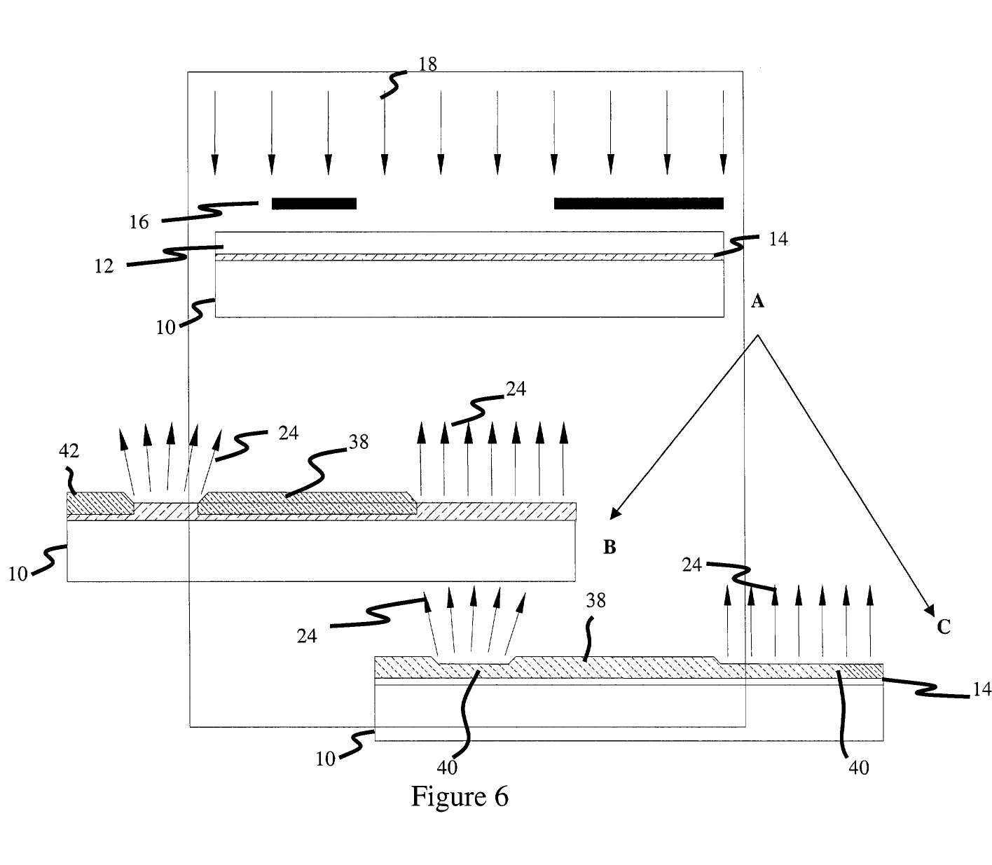

FIG. 6 is a schematic diagram showing the creation of a photo-patterned layer topography definition from a polymerizable composite. In this figure, A is transformed into B, or A is transformed into C, depending on the relative magnitudes of the refractive indices of the monomer and the polymer binder in the polymerizable composite. Thus, B is the outcome if in A the RIₘₒₙₒₘₑᵣ is greater than RI_{polymer}, whereas C is the outcome if in A RIₘₒₙₒₘₑᵣ is about equal to RI_{polymer}.

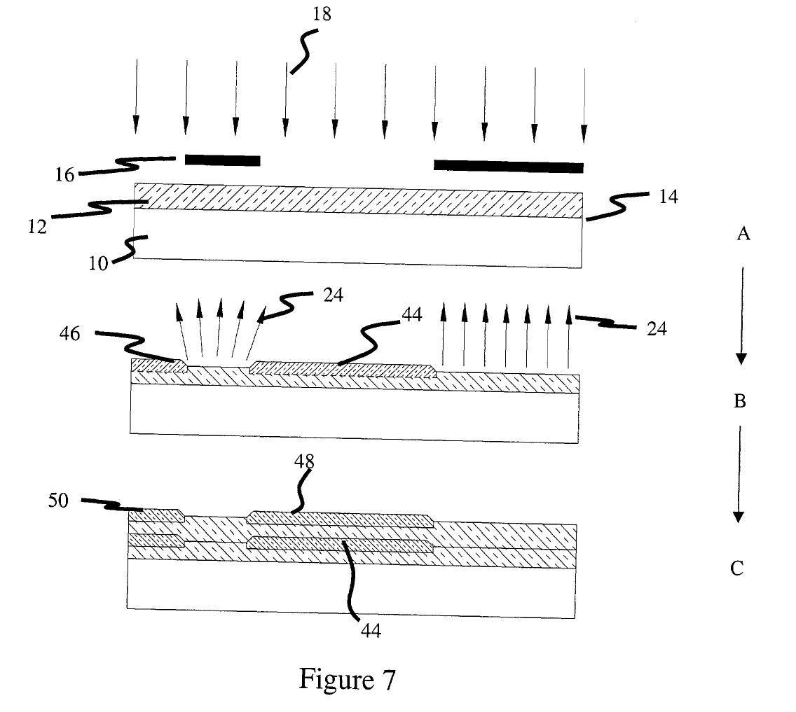

The process of forming an optical device structure, as described previously, can also be repeated for producing integral vertically stacked optical devices. FIG. 7 is a schematic diagram showing the creation of a photo-patterned stacked layer topography formed from a polymerizable composite. Thus, in one embodiment, the volatilization 24 can be followed by providing a second polymerizable composite to previous optical device structures 44 and 46, depositing a second layer of the second polymerizable composite on the optical device structure, obtained as previously described, patterning the second layer to define an exposed area and an unexposed area of the second layer, irradiating the exposed area of the second layer, and volatilizing the second uncured monomer to form new optical device structures 48 and 50. The second polymer composite comprises a second polymer binder and a second uncured monomer. The method described hereinabove can be used with a second polymerizable composite whose composition is either the same or different from the composition of the first polymerizable composite used to form the first optical device structure. Generally, to form waveguides with edge taper for vertical connection with a VCSEL, the curable monomer comprising the polymerizable composite should ideally have a higher refractive index than the polymeric material resulting after the radiation-induced curing step and the subsequent bake step.

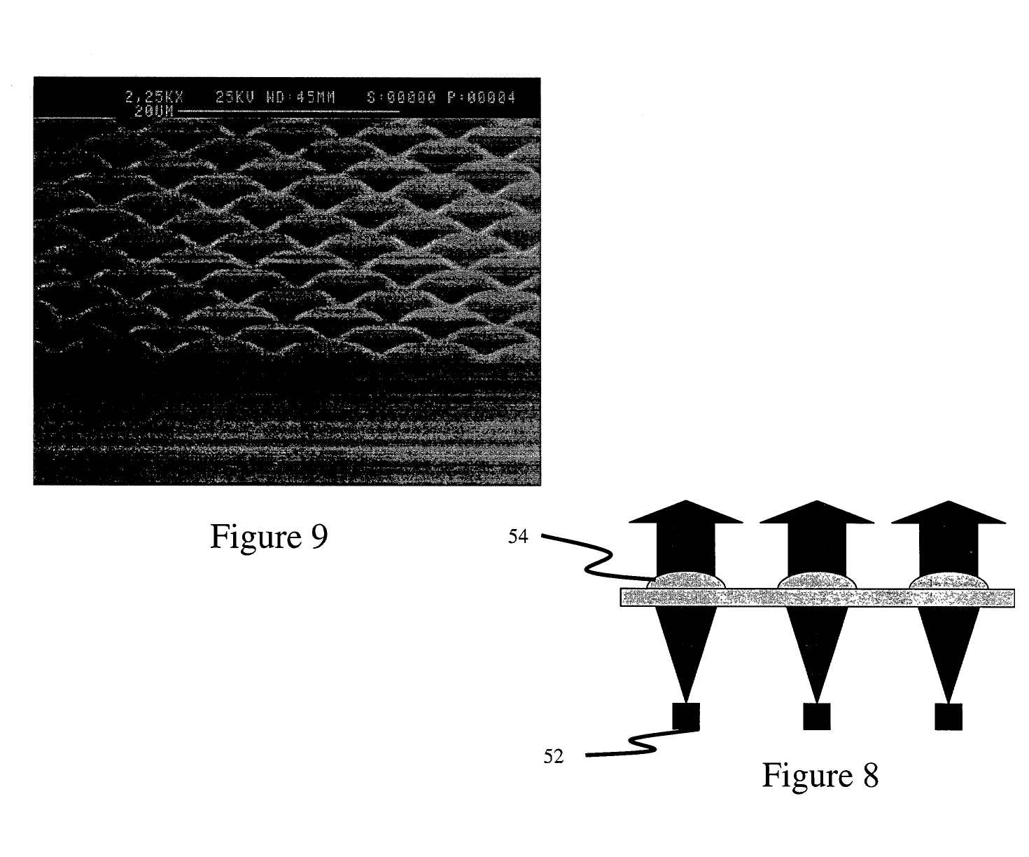

The aforementioned approaches to building optical device structures can have many potential applications in the fabrication of miniature optical devices. FIG. 8 is a schematic diagram illustrating creation of a VCSEL-integrated micro-lens array. The dome shaped structures 52 that can be formed by the method of the invention can act as a beam-focusing micro-lens array. By a proper choice of a radiation-polymerizable monomer, polymer binder, and masking conditions, an array of identical optical devices, or optical devices having a range of thicknesses and refractive indices can be created, each of which can be integrated with a VCSEL 50, as shown in FIG. 8.

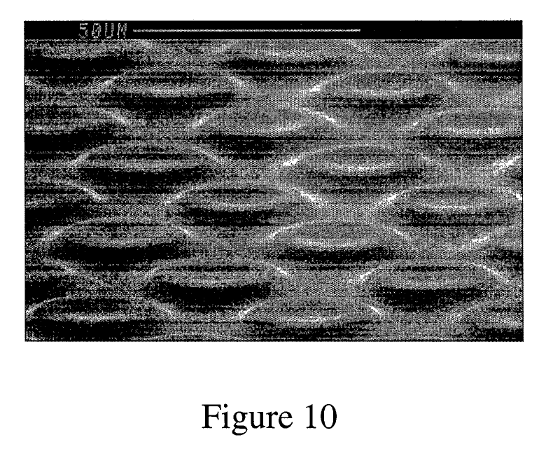

FIG. 9 is a scanning electron micrograph showing a plurality of dome-shaped structures formed from a post-irradiation post-bake step of a 60:40 mixture by weight of poly(methyl methacrylate) and CY 179. Each dome-shaped structure shown in FIG. 9 has a diameter of about 5 microns. By using the method described above and a larger sized mask, larger dome-shaped optical device structures can also be created. The dome-shaped structures formed as shown in FIG. 9 may also include dimple-structures located at approximately the center of each dome-shaped structure. Each dimple-shaped structure shown in FIG. 9 has a diameter of about 5 microns. FIG. 10 is a scanning electron micrograph showing a plurality of dome-shaped structures formed from a post-irradiation post-bake step of a 60:40 mixture by weight of poly(methyl methacrylate) and CY 179. Each dome-shaped structure shown in FIG. 10 has a diameter of about 24 microns.

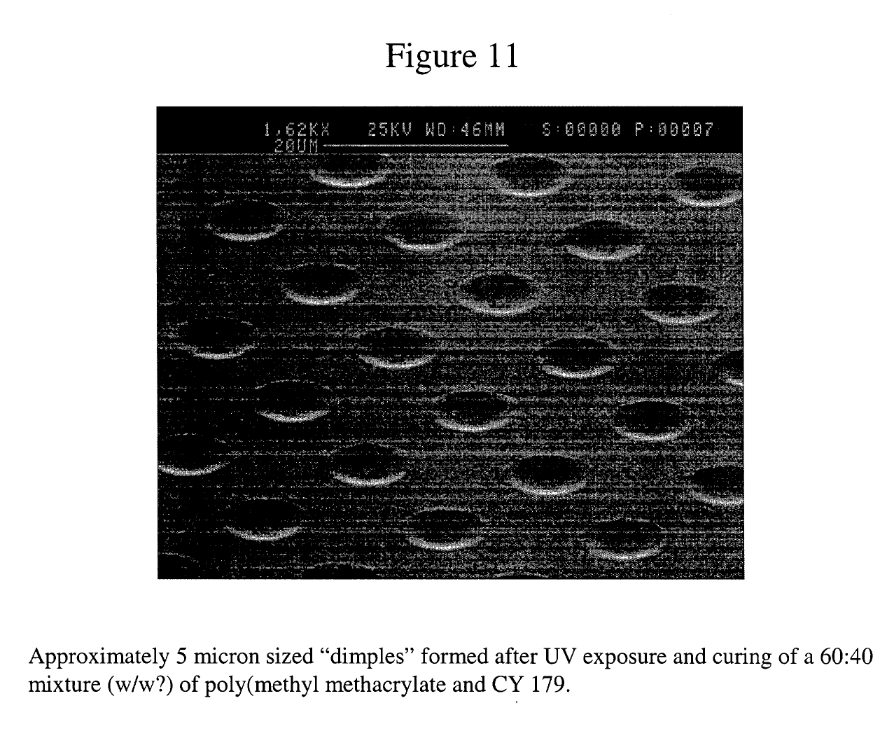

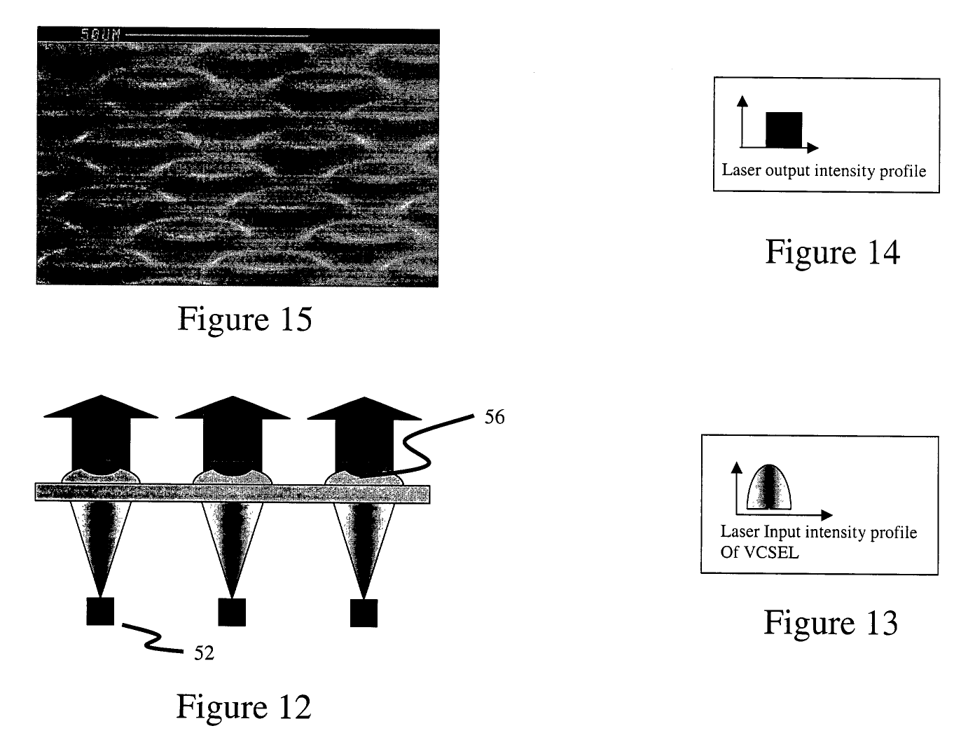

FIG. 11 is a scanning electron micrograph showing dimple-shaped structures formed from a post-irradiation post-bake step of a 60:40 mixture by weight of poly(methyl methacrylate) and CY 179. These dimple-shaped structures have the potential to function as beam shaping lenses when integrated with a VCSEL. FIG. 12 is a schematic diagram illustrating creation of a VCSEL-integrated micro beam-shaping lens array. A divergent laser beam from the VCSEL 52 passing through the convex surface 56 of the dimple can emerge as a focused parallel beam. FIG. 13 is a plot showing the input intensity profile of the VCSEL laser source across the convex surface of the dimple-shaped optical device structure. FIG. 14 is a plot showing the output intensity profile of the VCSEL laser source across the concave surface of the dimple-shaped optical device structure. It can be seen that the wavelength spread of the beam after passing through the dimple-shaped topography is narrower than that produced by the VCSEL 52. The formation of such dimple-shaped structures is illustrated in FIG. 15, which is a scanning electron micrograph showing domes, each having a diameter of approximately 24-microns, formed after UV exposure and curing of a 60:40 mixture by weight of poly(methyl methacrylate) and CY 179.

The substrate may be any material on which it is desired to establish an optical device structure. The substrate material may, for example, comprise a glass, quartz, plastic, a ceramic, a crystalline material, and a semiconductor material, such as, but not limited to, silicon, silicon oxide, gallium arsenide, and silicon nitride. In one embodiment, the substrate is a silicon wafer that is known to have high surface quality and excellent heat sink properties. In another embodiment, the substrate comprises a clad layer comprising an optical device structure.

The methods described above can be used to define optical device structures, such as mirrors, waveguides, and lens components. The process enables the formation of waveguide structures with controlled refractive index and smooth, tapered edges to allow vertical interconnection between the electronic portion of the electro-optic modules and the optical bench portion, or vertical connection between the fiber optic cables and the optical bench. Furthermore, the optical device structures described hereinabove can be formed without use of reactive ion etching or development, thus making the process more environmentally friendly. The tapered edges can be used as a mirror to direct VCSEL or optical fiber emission into the horizontal optical bench. The polymeric composite material having the desired refractive index gradient will define the waveguide path. In specific embodiments, the optical device structure comprises at least one of a waveguide, a 45-degree mirror, and combinations thereof.

Another aspect of the invention is to create a range of tailor-made topographic profiles that may be used for forming optical devices having more complex architectures. A key feature of the method is that it comprises a radiation-induced polymerization of the monomer such that only a portion of the polymerizable monomer present in a polymerizable composite is polymerized. The remaining monomer is volatilized in the succeeding bake step. This process of incomplete polymerization can lead to optical devices having surface topographies, compositional changes, and properties that are potentially different from those where all of the monomer in the exposed area is polymerized. This process can be carried out using a masking system to permit selection of one or more radiation-polymerized regions and one or more uncured monomer regions, thus leading to a variety of topographic profiles in the resulting optical device structures. Furthermore, all embodiments of a method of forming an optical device structure that have been previously described herein apply to the method of forming the topographic profile described hereinabove.

The features of the present invention are illustrated by the following examples.

### EXAMPLE 1

Example 1 describes the preparation of a surface topography comprising a polymeric composite material derived from Udel polysulfone and CY 179 using UV-irradiation.

Into a suitable clean glass container, 60 grams of low color grade polysulfone polymer (Udel P-3703, available from Solvay Advanced Polymers, Alpharetta, Ga.) was added along with 210 grams of anhydrous anisole. The blend was warmed to about 50° C. and mixed for about 24 hours to dissolve the polymer. To this mixture was added 20 grams of CY179 epoxy monomer, 0.5 gram of Cyracure UVI-6976, and 0.3 gram of Irganox 1010. The mixture was blended to completely intermix all components and filtered prior to use through a nominal 0.5 micron membrane filter to give the polymerizable composite. A 5 micron thick film of the polymerizable composite was prepared on a glass substrate by spin coating the material at 3000 revolutions per minute (rpm) for 30 seconds and heating on a hotplate for 5 minutes at 80° C. to remove the solvent. A patterned chrome image on a quartz plate was used to expose and define a pattern on the film. A 10 second exposure using a Karl Suss contact printer was used. After exposure, the sample was baked on a hotplate for 10 minutes at 80° C., ramped up to 175° C. over 1 hour, and held at 175° C. for 30 minutes. Surface profilometry measurements of the resulting surface topography indicated approximately a 1.2 micron step between the lower un-exposed film surface (4 microns thick) and the upper exposed film surface (5.2 microns thick). Weight loss measurements on other test samples receiving either blanket UV exposure or no exposure, followed by the bake step indicated about 99% epoxy loss from unexposed areas, whereas exposed areas lost less than 5% epoxy. The refractive index for the exposed areas was about 1.9% lower than that measured in the unexposed areas.

### EXAMPLE 2

This Example describes the preparation of a surface topography comprising a polymeric composite material derived from an acrylate copolymer containing about 75% by weight of poly(methyl methacrylate) and 25% poly(tetrafluoropropyl methacrylate) and CY 179 using UV-irradiation.

Into a glass container, capable of being sealed under vacuum, was distilled 19 grams of tetrafluoropropyl methacrylate, followed by addition of 56 grams of methyl methacrylate, 93 grams of cyclohexanone, 0.15 gram of N-dodecanethiol, and 0.19 gram of benzoyl peroxide. The mixture was degassed and sealed under vacuum. After being heated with mixing at about 75° C. for about 24 hours, followed by further heating at about 80° C. for about 24 hours, the resulting mixture was cooled and treated with 55.5 grams of anisole. The resulting blend was a viscous, clear, and colorless acrylate copolymer consisting of about 75% poly(methyl methacrylate) and 25% poly(tetrafluoropropyl methacrylate), present as 33.5% solids in the cyclohexanone-anisole mixed solvent. An additional 10.7 grams of anisole, 5 grams of CY179 epoxy monomer, 0.15 gram of Irganox 1010, and 0.13 gram of Cyracure UVI-6976 were added to a 35 gram portion of the blend. The resulting polymerizable composite contained about 70% by weight of the acrylate polymer and 30% by weight of the epoxy monomer. A 5-micron thick film of the polymerizable composite was prepared on a glass substrate by using the procedure described in Example 1. After patterning, irradiating and baking the film as described in Example 1, surface profilometry measurement of the topography of the resulting film of the composite polymeric material indicated a 3.7 micron film thickness in the UV-exposed areas, and a 2.6 micron film thickness in the unexposed areas. The refractive index for the exposed areas was about 1.4% higher than that measured in the un-exposed areas.

The results from Example 1 and Example 2 indicate that after the bake step, the composition of the UV-exposed and the unexposed areas differ significantly from each other. For Example 1, in the UV-exposed areas, the composite polymeric material showed a composition corresponding to approximately 76 percent by weight of polysulfone and 24 percent by weight of the epoxy polymer linkages derived from CY 179, similar to the starting composite material. After baking, however, the composite polymeric material in the unexposed areas showed a composition corresponding to approximately 95 percent by weight of polysulfone and 5 percent by weight of the epoxy polymer linkages derived from CY 179.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of forming an optical device structure, said structure having a first region and a second region, the method comprising the steps of:
providing a polymerizable composite comprising a polymer binder and an uncured monomer,
depositing said polymerizable composite on a substrate to form a layer,
patterning said layer to define an exposed area and an unexposed area of said layer,
irradiating said exposed area of layer, and
volatilizing said uncured monomer to form said optical device structure.

2. The method of claim 1, wherein the step of volatilizing forms a surface topography and a compositional change between said first region and said second region.

3. The method of claim 2, wherein said surface topography is graded between said exposed area that has been irradiated and said unexposed area.

4. The method of claim 3, wherein said surface topography includes at least one step.

5. The method of claim 4, wherein said step has at least one of an angled profile, a concave profile, and a convex profile.

6. The method of claim 4, wherein said step forms an angle from about 5 degrees to about 90 degrees with respect to the surface of the substrate.

7. The method of claim 2, wherein said compositional change creates a change in at least one of coefficient of thermal expansion, glass transition temperature, refractive index, birefringence, light transmission, modulus, dielectric properties, and thermal conductivity of said optical device structure.

8. The method of claim 2, wherein said compositional change creates a gradient in refractive index between said first region and said second region.

9. The method of claim 8, wherein said refractive index gradient is at least 0.2 percent.

10. The method of claim 1, wherein said polymer binder comprises at least one of a cyclic olefin copolymer, an acrylate polymer, a polyester, a polyimide, a polycarbonate, a polysulfone, a polyphenylene oxide, a polyether ketone, a polyvinyl fluoride, and combinations thereof.

11. The method of claim 10, wherein said acrylate polymer is at least one of a poly(methyl methacrylate), poly(tetrafluoropropyl methacrylate), poly(2,2,2-triflouroethyl methacrylate), poly(tetrafluoropropyl methacrylate), copolymers comprising structural units derived from an acrylate polymer, and combinations thereof.

12. The method of claim 1, wherein said uncured monomer comprises at least one of an acrylic monomer, a cyanate monomer, a vinyl monomer, an epoxide-containing monomer, and combinations thereof.

13. The method of claim 1, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate ester.

14. The method of claim 1, wherein the step of irradiating said exposed area of said layer comprises irradiating said exposed area with ultraviolet radiation.

15. The method of claim 1, wherein the step of irradiating said exposed area of said layer comprises irradiating said exposed area with a direct-write laser.

16. The method of claim 1, wherein the step of patterning said layer comprises patterning said layer using a mask.

17. The method of claim 16, wherein said mask comprises a gray scale mask.

18. The method of claim 16, wherein the step of patterning said layer comprises patterning an array on said layer.

19. The method of claim 1, wherein the step of volatilizing said uncured monomer further includes:
providing a second polymerizable composite comprising a second polymer binder and a second uncured monomer;
depositing a second layer of said second polymerizable composite on said optical device structure;
patterning said second layer to define an exposed area and an unexposed area of said second layer,
irradiating said exposed area of second layer, and
volatilizing said second uncured monomer.

20. The method of claim 19, wherein said second polymerizable composite has a composition that is substantially the same as that of said polymerizable composite.

21. The method of claim 19, wherein said second polymerizable composite has a composition that is different from that of said polymerizable composite.

22. The method of claim 1, wherein said substrate comprises a clad layer.

23. The method of claim 1, wherein said optical device structure comprises a waveguide, a 45-degree mirror, and combinations thereof.

24. The method of claim 1, wherein said first region is a clad layer and said second region is a core layer.

25. A method of forming a topographic profile in an optical device structure having a first region and a second region, the method comprising the steps of:
providing a polymerizable composite, said polymerizable composite comprising at least one polymer binder and at least one uncured monomer, wherein said polymer binder comprises one of a cyclic olefin copolymer, an acrylate polymer, a polyimide, a polycarbonate, a polysulfone, a polyphenylene oxide, a polyester, a polyether ketone, a polyvinyl fluoride, or combinations thereof; and said uncured monomer comprises at least one of an acrylic monomer, a cyanate monomer, a vinyl monomer, an epoxide-containing monomer, and combinations thereof;
depositing said polymerizable composite on a surface of a substrate to form a layer;
patterning said layer to define an exposed area and an unexposed area of said layer;
curing a portion of said layer to form a polymerized portion and an uncured portion;
removing said uncured monomer from at least one of said polymerized portion and said uncured portion, wherein the removal of said uncured monomer forms said topographic profile, said topographic profile comprising a change in at least one of composition, refractive index, coefficient of thermal expansion, glass transition temperature, birefringence, light transmission, modulus, dielectric properties, and thermal conductivity of said optical device structure.

26. The method of claim 25, wherein said surface topography includes at least one step.

27. The method of claim 26, wherein said step has at least one of an angled profile, a concave profile, and a convex profile.

28. The method of claim 26, wherein said step forms an angle from about 5 degrees to about 90 degrees with respect to the surface of the substrate.

29. The method of claim 25, wherein said step of curing a portion of said layer to form a polymerized portion and an uncured portion comprises irradiating said exposed area.

30. The method of claim 25, wherein said change in composition creates a gradient in refractive index between said exposed area and said unexposed area.

31. The method of claim 25, wherein said change in refractive index comprises a gradient in refractive index.

32. The method of claim 25, wherein irradiating said exposed comprises irradiating said exposed area with one of ultraviolet radiation and a direct-write laser.

33. The method of claim 25, wherein the step of patterning said layer comprises using a mask to define said exposed area for irradiation.

34. The method of claim 25, wherein said polyimide is one of a polyetherimide, a siloxane-containing polyetherimide, a polyimide comprising the building blocks, 2,2′-bis[4-(3,4-dicarboxyphenoxy)phenyl] propane dianhydride, 1,3-phenylenediamine, benzophenonetetracarboxylic acid dianhydride and 5(6)-amino-1-(4′-aminophenyl)-1,3-trimethylindane; and combinations thereof.

35. The method of claim 25, wherein said polycarbonate is a siloxane-containing polycarbonate.

36. The method of claim 25, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate ester.

37. The method of claim 33, wherein said mask comprises at least one gray scale mask.

38. The method of claim 25, wherein the step of patterning said layer comprises patterning an array on said layer.

39. The method of claim 25, wherein said optical device structure comprises at least one of a waveguide, a 45-degree mirror, and combinations thereof.

40. The method of claim 25, wherein said first region is a clad layer and said second region is a core layer.

41. A method of making an optical device structure, said structure having a first region and a second region, the method comprising the steps of:
providing a polymerizable composite comprising at least one polymer binder and at least one uncured monomer,
depositing a layer of said polymerizable composite on at least one substrate, said substrate comprising a clad layer,
patterning said layer using a mask to define an exposed area and an unexposed area of said layer,
irradiating said exposed area, and
volatilizing said uncured monomer to form said optical device structure, wherein the step of volatizing forms a topography and a compositional change in said optical device structure.

42. The method of claim 41, wherein said surface topography is graded between said exposed area and said unexposed area.

43. The method of claim 41, wherein said surface topography includes at least one step.

44. The method of claim 42, wherein said step has at least one of an angled profile, a concave profile, and a convex profile.

45. The method of claim 42, wherein said step forms an angle from about 5 degrees to about 90 degrees with respect to the surface of the substrate.

46. The method of claim 41, wherein said compositional change creates a change in at least one of coefficient of thermal expansion, glass transition temperature, refractive index, birefringence, light transmission, modulus, dielectric properties, and thermal conductivity of said optical device structure.

47. The method of claim 41, wherein said compositional change creates a gradient in refractive index between said first region and said second region.

48. The method of claim 46, wherein said refractive index gradient is at least 0.2 percent.

49. The method of claim 41, wherein said polymer binder comprises a cyclic olefin copolymer, an acrylate polymer, a polyimide, a polyester, a polycarbonate, a polysulfone, a polyphenylene oxide, a polyether ketone, a polyvinyl fluoride, and combinations thereof

50. The method of claim 48, wherein said polyimide is at least one of a polyetherimide, a siloxane-containing polyetherimide, and combinations thereof.

51. The method of claim 48, wherein said polycarbonate is a siloxane-containing polycarbonate.

52. The method of claim 41, wherein said uncured monomer comprises at least one of an acrylic monomer, a cyanate monomer, a vinyl monomer, an epoxide-containing monomer, and combinations thereof.

53. The method of claim 51, wherein said uncured monomer comprises at least one of benzyl methacrylate, 2,2,2-trifluoroethyl methacrylate, tetrafluoropropyl methacrylate, methyl methacrylate, 3-4-epoxycyclohexylmethyl-3,4-epoxycyclohexane carboxylate, bisphenol A diglycidyl ether, bisphenol F diglycidyl ether, styrene, allyl diglycol carbonate, and cyanate esters.

54. The method of claim 41, wherein the step of irradiating said exposed area comprises irradiating said exposed area with an ultraviolet radiation source.

55. The method of claim 41, wherein the step of irradiating said exposed area comprises irradiating said exposed area with a direct-write laser.

56. The method of claim 41, wherein the step of patterning said layer comprises patterning said layer using a mask.

57. The method of claim 41, wherein the step of patterning said layer comprises patterning an array on said layer.

58. The method of claim 41, wherein the step of volatilizing said uncured monomer further includes:
providing a second polymerizable composite comprising at least one polymer binder and at least one uncured monomer,
depositing a layer of said second polymerizable composite on at least one substrate comprising a clad layer,
patterning said layer using a mask to define an exposed area and an unexposed area of said layer,
irradiating said exposed area of layer with an ultraviolet radiation source, and
volatilizing said uncured monomer to form said optical device structure, wherein the step of volatizing forms a topography and a compositional change in said optical device structure.

59. The method of claim 41, wherein said optical device structure comprises at least one of a waveguide, a 45-degree mirror, and combinations thereof.

60. The method of claim 41, wherein said first region is a clad layer and said second region is a core layer.
